(19) United States
(12) Patent Application Publication
(10) Pub. No.: US 2019/0034392 A1
(43) Pub. Date: Jan. 31, 2019

(54) CORRELATION ACROSS HIERARCHICAL SERIALIZATION BOUNDARIES

(71) Applicant: CA, Inc., New York, NY (US)

(72) Inventor: Dayne Howard Medlyn, Windsor, CO (US)

(21) Appl. No.: 15/664,914

(22) Filed: Jul. 31, 2017

(51) Int. Cl. G06F 17/22; G06F 17/27

(52) U.S. Cl. CPC G06F 17/2247; G06F 17/272; G06F 17/277; G06F 17/2241; G06F 17/2258

(57) ABSTRACT

A system can stream parse structure elements of a graphical interface object to modify and render the graphic interface object. Stream parsing the structure elements includes, for a first structure element within a first field rendering level, comparing one or more correlation tokens to the first structure element. Based on the comparing, a content handler determines that a portion of the first structure element corresponds to at least one of the correlation tokens. In response, at least in part, to determining that a correlation associated with the corresponding portion of the first structure element is not resolved within the first structure element, the content handler copies the corresponding portion to a resolution cache. During subsequent stream parsing of each of one or more of the structure elements, the content handler compares the copied corresponding portion to the structure element, and in response to identifying a correlation value based at least in part on said comparing, replaces within the graphical interface object the corresponding portion with the correlation value.

### BACKGROUND

The disclosure generally relates to the field of data processing, and more particularly to processing graphical interfaces.

Markup languages such as Extensible Markup Language (XML) are commonly utilized to communicate between applications. Various protocols have been developed for processing XML files such as Simple API for XML (SAX) and Document Object Model (DOM). The SAX API is used to process serialized XML streams. In contrast, the DOM loads an XML document into memory to generate and manipulate a resultant in-memory tree.

### BRIEF DESCRIPTION OF THE DRAWINGS

Embodiments of the disclosure may be better understood by referencing the accompanying drawings.

FIG. 1 is a block diagram depicting a system for modifying hierarchically structured XML objects in accordance with some embodiments;

FIG. 2A is a block diagram illustrating a system for rendering GUI objects using a dual-stage stream parsing engine in accordance with some embodiments;

FIG. 2B depicts an example XML file processed by the system in FIG. 2A;

FIG. 2C illustrates an example modified XML generated by the system in FIG. 2A;

FIG. 3 is a flow diagram depicting operations and functions for rendering a GUI object utilizing dual-stage stream parsing in accordance with some embodiments;

FIG. 4 is a flow diagram illustrating operations and functions for modifying a GUI object in accordance with some embodiments; and

FIG. 5 is a block diagram depicting an example computer system that processes graphical interface objects in accordance with some embodiments.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

### INTRODUCTION

Parsers generally include program code for converting an encoded representation of a data set into an in-memory representation for an application program, possibly a host application, to utilize. When stream parsing data objects, such as graphical interface objects, data is processed serially in an event-based manner. Streaming parsers for example are distinguished from tree-based parsers in that a streaming parser does not build a tree of interrelated memory objects representing a portion or all of an input file. Instead, a streaming parser generates a series of event instructions corresponding to a series of input characters or tokens.

Markup language objects may comprise data objects that internally define multiple hierarchical display rendering levels. The rendering levels may be represented as structure elements including tables, columns, rows, etc. As utilized herein, a “structure element” may be generally characterized as a data object element such as an XML file column element that designates, defines, or otherwise specifies the arrangement (i.e., absolute and/or relative positioning) of displayed objects within one or more fields in a graphical display. For instance, structural elements may include tables, columns, row, and cells that define the absolute and/or relative positioning of display elements such as individual fields and cells within a display object such as a GUI. Structure elements may also include containers, which may be generally characterized as wrappers that may include container-specific field definition(s) as well as incorporating (wrapping) sub-elements including other containers and tables. The relations among different categories of structure elements (e.g., column type and row type structure elements) are hierarchical in terms of the display layout characteristics of the rendering program which determines how a particular field in a display will be represented based in part on the override nature of the hierarchical relations. For example, a particular data item that is ultimately rendered in a particular field that is defined in part by a column element, in part by a row element, and in part by a cell element is determined based on the hierarchical relation among columns, rows, and cells. XML is a markup language that represents such hierarchical display relations.

Some applications such as GUI applications may include or otherwise utilize stream parsers such as SAX for quickly processing large graphical interface objects such as large XML files. The embodiments described herein provide systems, devices, components, and techniques for stream parsing and modifying graphical interface objects such as XML files that include hierarchically rendered structure elements whose structure that may inherently result in hierarchical serialization boundaries during stream parsing and application processing.

### Overview

A system includes components for correlating objects across display layout hierarchies during serialized processing of a graphical interface object. Display description Information contained in the graphical interface object includes hierarchically defined structure elements. Each structure element may contain sub-elements having dependency relations with other element or sub-elements within the graphical interface object. As the graphical interface object is serially stream parsed, the dependency relations of each structure elements are identified and the system determines whether the dependency is resolved within the structure element. Based on the dependency identifications and resolution determinations, portions of the structure elements are copied to a resolution cache. The cached portions of the structure elements are utilized in continued stream parsing of the graphical interface object to identify corresponding resolution values that are utilized to modify the graphical interface object.

### Example Illustrations

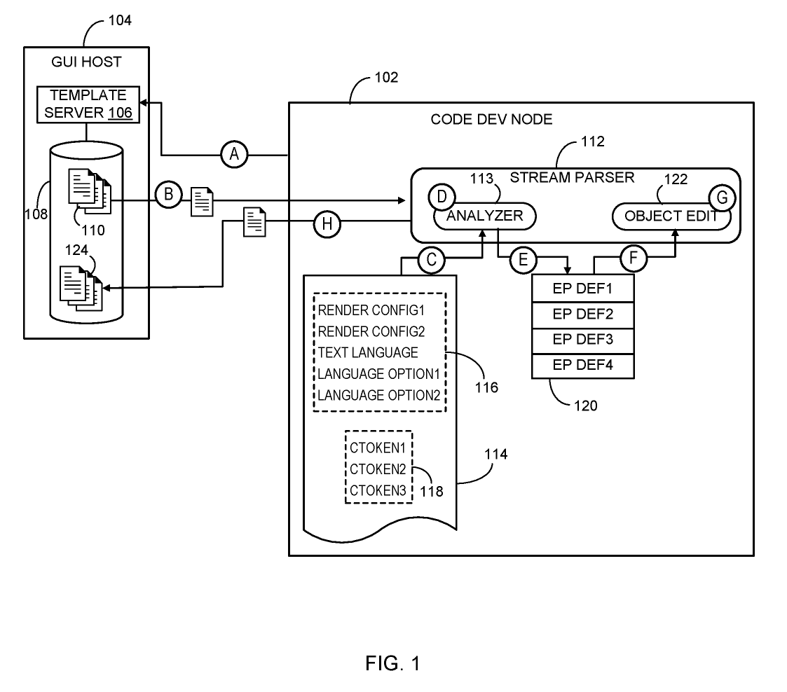

FIG. 1 is a block diagram depicting a system for modifying hierarchically structured XML objects in accordance with some embodiments. The system generally includes a GUI host system 104 that is communicatively coupled with a code development node 102. Host system 104 includes a template server 106 that may be configured using any combination of hardware, software and other code and data constructs for processing client requests such as from code development node 102. For example, template server 106 may comprise a host template server application executing on a suitable processor platform that receives, processes, and responds to client requests via a network interface.

Host system 104 further includes a storage system 108 that is communicatively and otherwise logically coupled to template server 106. Storage system 108 is configured using any combination of hardware software and other code and data constructs for storing template files 110. For example, storage system 108 may include program code in the form of one or more of a storage operating system, a file system, and a file-based or object-based application layer storage application. Storage system 108 further includes storage hardware systems and devices such as disk arrays and solid state drives (SSDs) as well as corresponding control and interface hardware and software such as a storage specific operating system. Storage system 108 further includes interface devices and components for interacting with template server 106, such as for provisioning one or more of template files 110 in response to requests from template server 106.

Development node 102 includes systems, devices, and hardware and software components that are mutually configured for generating and modifying template objects such as graphical interface objects. Development node 102 includes network interface and communication components (not depicted) for obtaining template objects/files from host system 104. Development node 102 further includes a stream parser 112 that receives streaming input data from the template files received from host system 104. Stream parser 112 is configured using any combination of program code and data constructs for receiving and processing a serialized input stream of template object characters, translating the characters into tokens which are processed in accordance with the operations and function described in further detail herein. For example, stream parser 112 is depicted as including an analyzer unit 113 and an object edit unit 122 that cooperatively function to modify template objects that include hierarchically layered display elements/objects in accordance with the embodiments disclosed herein.

FIG. 1 is annotated with a series of letters A-G. These letters represent stages of operation, each of which may be one operation or multiple operations. Although these stages are ordered for this example, the stages illustrate one example to aid in understanding this disclosure and should not be used to limit the claims. Subject matter falling within the scope of the claims can vary with respect to the order and specifics of some of the operations. At stage A, development node 102 generates and transmits a template file request to host system 104. The request specifies a file and/or file/type identifier (ID) that is processed by template server 106 to retrieve a corresponding template file from among stored template files 110. The request may specify an ID corresponding to a graphical interface template file that includes structure elements and display property elements that together define a graphical interface object. For instance, the template file may be an XML file that includes multiple hierarchically rendered structure elements such as tables, columns, rows, and cells.

At stage B, the retrieved template file is transmitted such as across a network interface to development node 102 at which it may be pre-processed (e.g., buffered) in preparation for being input to stream parser 112. Within stream parser 112, serialized character content (either received serially from host system 104 or serialized within node 102) of the template file is received and processed by analyzer unit 113 to tokenize the input stream. Sets of one or more of the corresponding sequence of tokens represent objects within the retrieved template file. For example, if the template file is an XML file, sets of one or more of the tokens represent object constructs such as structure elements and sub-elements as well as display property elements that together may define a graphical interface object.

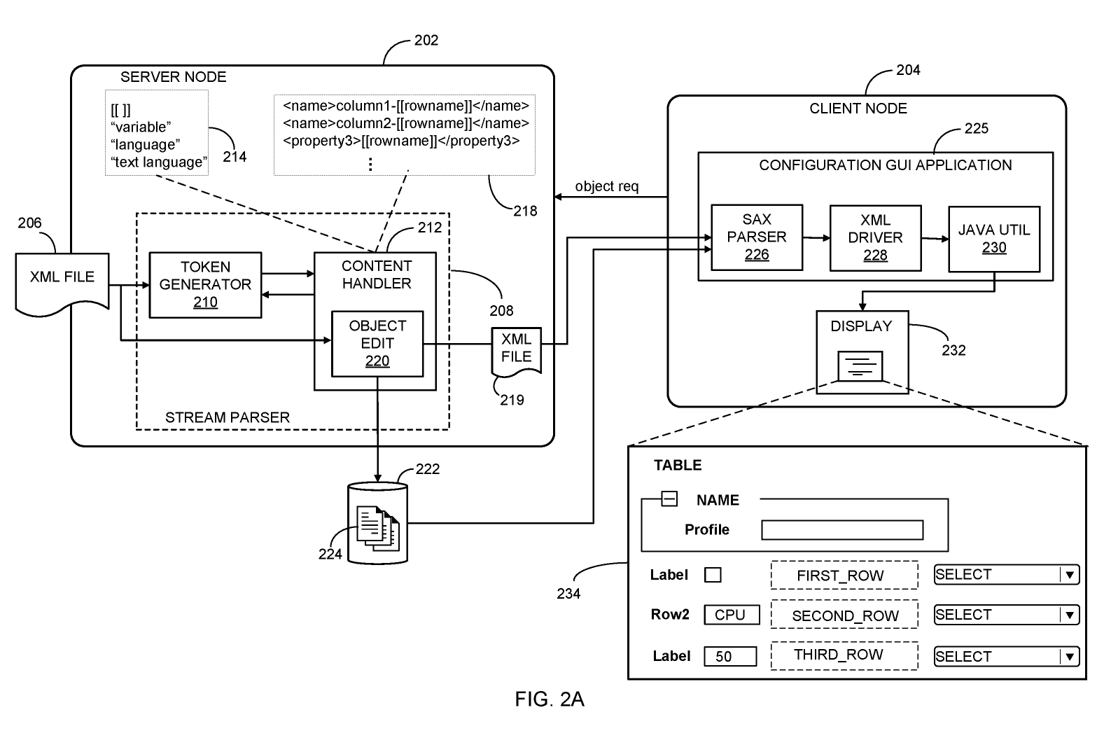

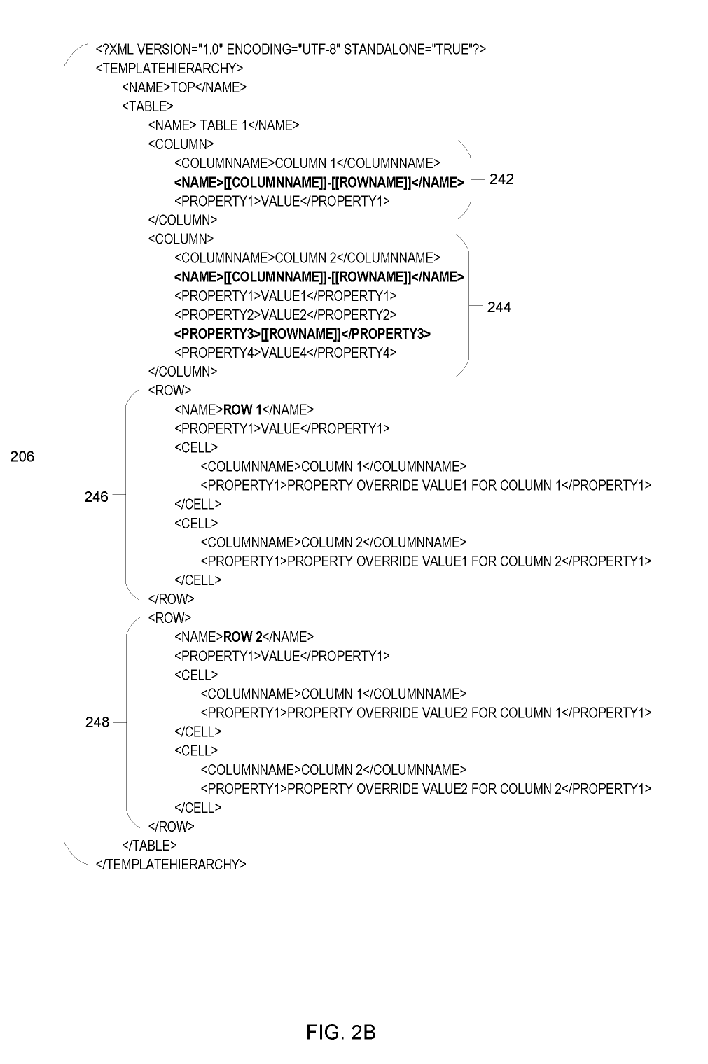

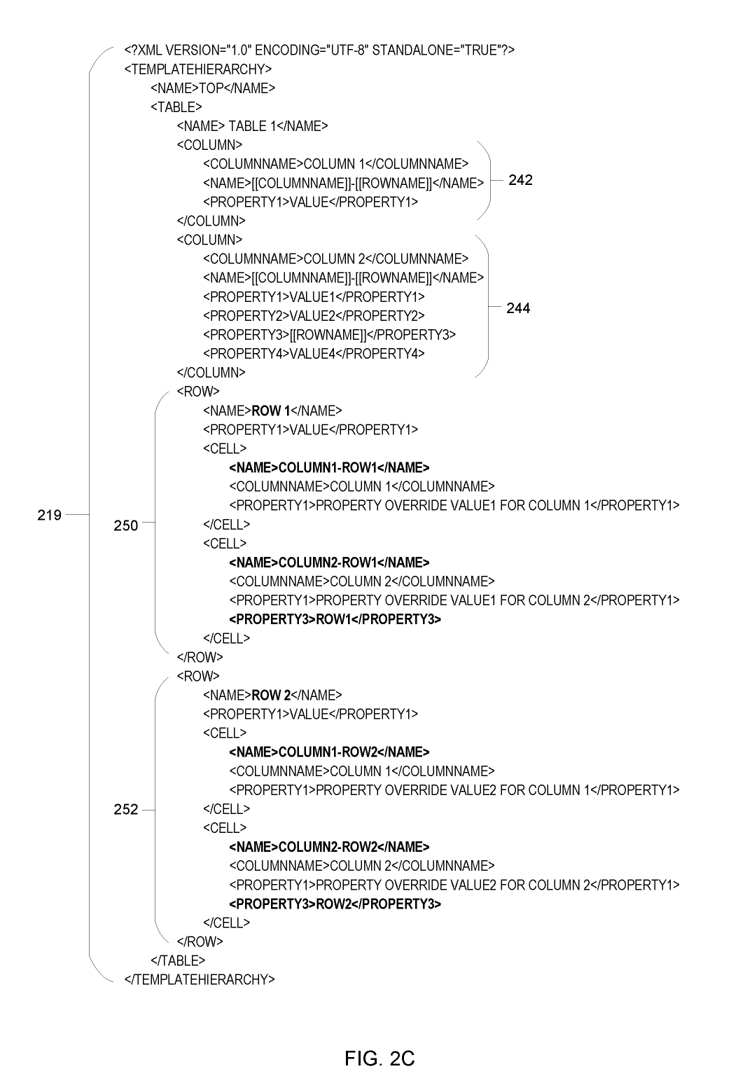

As depicted and described in further detail with reference to FIG. 2A, in addition to tokenizing, analyzer unit 113 is configured to perform content handling operations associated with the sequence of tokens. As part of content handling, analyzer unit 113 is configured to compare each of the sequence of input file tokens with pre-specified correlation tokens to identify or otherwise determine file elements that have or share (i.e., co-dependent) a dependent relation with one or more other elements within the same template file. For example, at stage C, analyzer unit 113 reads a configuration settings file 114 that includes correlation tokens 118 and operation context data 116. Each of correlation tokens 118 comprises a data element, such as a text/character string, that represents a respective dependency relation indicator in accordance with the configuration properties (e.g., syntax and/or semantics) of the retrieved template file or language with which all or portions of the file are generated. Context data 116 comprises a set of entries that each represents a contextual operational setting in which the object represented by the retrieved file will be processed during runtime. Context data 116 includes RENDER CONFIG1 and LANGUAGE OPTION1 entries that respectively define two distinct aspects of the manner in which elements within the retrieved file may be rendered during runtime. For instance, the RENDER CONFIG1 entry may define default positioning or masking of display objects while LANGUAGE OPTION1 may define a particular text language such as French as the default display language.

At stage D, analyzer unit 113 sequentially compares each of the sequence of tokens with the correlation tokens 118 to determine a correspondence between a portion of an object/file element represented by one or more of the tokens and one or more of the correlation tokens. A determined correspondence between a file element portion (i.e., all or a sub-portion of the element) and a correlation token is effectively a determined dependency or potential dependency relation between the file element and another file element within the retrieved file. This relation, also referred to herein as a correlation, may take a variety of forms. For example, the correlation may be a dependency of a value of the currently processed file element property on a value of a file element property that will be subsequently processed in the sequence of tokens. In other instances, the correlation may be a dependency of a value of the currently processed file element property on another currently processed file element property. In the former example of dependency of an element on a subsequently processed element, analyzer unit 113 determines that the correlation is not resolved within the currently processed file element. In other words, the currently processed file element itself, as a nested element or otherwise, does not include the element value on which the corresponding portion of the file element depends. In the latter example, the analyzer determines that the correlation is resolved within or in association with the currently processed file element.

At stage E, in response to determining that the correlation associated with the corresponding portion of the file element is not resolved within the currently processed file element, analyzer unit 113 copies the corresponding portion to a resolution cache. In the depicted embodiment, the resolution cache comprises a memory space allocation 120 in which multiple portions of file elements (e.g., text/symbol strings) have been similarly cached for use during processing of subsequent portions of the sequence of tokens. The file element portions may effectively comprise element property definitions (e.g., EP DEF1, EP DEF2) and are read at stage F and processed at stage G by object edit unit 122 to modify a copy of the retrieved file which in addition to being input to the tokenization process is also received as input by object edit unit 122. At stage H, the modified template file is transmitted to host system 104 which stores the file among a set of pre-parsed files 124.

FIG. 2A is a block diagram illustrating a system for rendering GUI objects using a dual-stage stream parsing engine in accordance with some embodiments. The systems, hardware devices, and hardware and program code components depicted and described in FIG. 2A may be configured to perform the operations and functions described with reference to FIG. 1. FIGS. 2B and 2C respectively depict a GUI object in the form of an XML file that is input to and modified by the system illustrated in FIG. 2A. Referring to FIG. 2A in conjunction with FIGS. 2B and 2C, the system includes a server node 202 that is communicatively coupled with a client node 204. Server node 202 stores or retrieves GUI template files that in the depicted embodiment may comprise XML files including an XML file 206. Server node 202 is configured using any combination of hardware and software to respond to template object requests from client node 204 by implementing a first stage parsing process. In some embodiments, the first stage parsing process can be used to generate a modified version of a requested XML file which can then be transmitted or stored.

The first stage parsing is implemented by a stream parser 208 within server node 202. Stream parser 208 is configured using any combination of program code and data constructs for modifying an XML object such as XML file 206 that includes hierarchically rendered display elements that would otherwise result in hierarchical serialization boundaries during stream parsing such as by a standard SAX parser. As shown, stream parser 208 includes a token generator 210 and a content handler 212. Token generator 210 is configured to perform the tokenization operations described with reference to FIG. 1 including reading an input stream of object characters and translating sets into corresponding tokens. The content of XML file 206 is received as a stream of characters that are translated to tokens that are serially received and processed by content handler 212. As part of processing the incoming sequence of tokens, content handler 212 access a set of correlation tokens including “[[ ]],” “variable,” “language,” and “text language.” The correlation tokens may be maintained in an allocated memory space 214 by content hander 212 during execution.

Content handler 212 is configured to process the tokens and generate corresponding event instructions (alternatively events) that may be sent to token generator 210 and/or to an object editor 220 within content handler 212. Essentially the output from content handler 212 comprises parsed XML file data in the form of the event instructions. In combination, content handler 212 and object editor 220 process the tokenized XML file to extract and replace element properties associated with structure elements (e.g., column element in XML) across hierarchical serialization boundaries. To this end, content handler 212 is configured to identify structure elements as being associated with particular tokens such as may represent tag identifiers such as <column>, <row>, etc. As depicted in FIG. 2B, for example, XML 206 includes multiple structure elements including column elements 242 and 244 and row elements 246 and 248.

As each structure element is identified within the token stream from token generator 210, content handler 212 determines whether the structure element includes display property elements or sub-elements (structure or display property) that indicate a dependency relation, or “correlation” as utilized herein, with another element. The determination of the existence of a dependency relation within the structure element may be performed by content handler 212 comparing one or more of the correlation tokens within execution memory space 214 with portions of the structure element. Content handler 212 may determine that a dependency relation within a currently processed structure element by determining a match or other interpretable logical association between portions (e.g., sub-elements) of the structure element and one or more of the correlation tokens within memory space 214. Having identified a dependency relation between a portion of the structure element (referred to herein as a “corresponding portion”) and another element within the graphical interface object, content handler 212 determines whether the “other” element is defined within a different hierarchical rendering level than the currently processed structure element. In a serialized stream parsing process, this determination may be implicitly made by affirmatively determining that the other element is not defined within the currently processed structure element.

For example, in response to identifying column element 242 as a structure type element, content handler 212 compares and determines a match or some other correspondence between the “[[ ]]” correlation token within memory space 214 and a field name element “<NAME>[[COLUMNNAME]]-[[ROWNAME]]</NAME>” within column element 242. In this case, content handler 212 has identified “COLUMNNAME” and “ROWNAME” as variables based on the correspondence of the double bracket syntax with the correlation token. In response to identifying the field name element as including the two variables, content handler 212 determines whether the dependency relation (i.e., correlation) associated with each of the variables is resolved within structure element 242. In the depicted example, content handler 212 determines that the “COLUMNNAME” variable is resolved by the <COLUMNNAME> element having a value/string “COLUMN 1.” In contrast to the intra-structure element resolution of “COLUMNNAME”, content handler 212 determines that the “ROWNAME” variable is not resolved within column element 242.

In response, to determining that the “ROWNAME” variable is not resolved within element 242, content handler 212 may copy the field name element containing the variables as an entry within a resolution cache which is represented as an allocated execution memory location 218. In some embodiments, content handler 212 copies a given “corresponding portion” of a structure element in response both to determining that an associated correlation is not resolved within the current structure element and also determining that the correlation is not resolved by an element property value cached within memory space 218.

After processing column element 242, content handler 212 receives and processes a tokenized version of column element 244 utilizing the same procedure as described for column element 242. During processing of column element 244, content handler 212 identifies an identically structured field name element containing the same two COLUMNNAME and ROWNAME variables. Also, content handler 212 identifies via comparing with the correlation tokens within memory space 214 a display property element having the tag ID <PROPERTY3> as including the ROWNAME variable. Similar to the processing of column element 242, content handler 212 copies the field name element “<NAME>[[COLUMNNAME]]-[[ROWNAME]]</NAME>” and the display property element “<PROPERTY3>[[ROWNAME]]</PROPERTY3>” into memory space 218 in response to determining that the correlations associated with the variable ROWNAME in each of these elements are not resolved within column element 244.

During parsing of subsequent structure elements within XML file 206, object editor 220 compares the cached entries within memory space 218 to components (e.g., sub-elements, display property elements, etc.) of each subsequent structure element. If, as depicted in FIGS. 2A and 2B, the copied portion of the structure element is an element property variable, processing of subsequent structure elements includes object editor 220 determining a match between the element property variable and an element property within the structure element, wherein the element property includes a property value and a property identifier. The comparison further includes determining that a sub-element within the structure element incorporates the element property variable. As shown in FIG. 2B, row elements 246 and 248 include row name elements <NAME>ROW 1</NAME> and <NAME>ROW 2</NAME>, respectively. In stream parsing sequence, object editor 220 compares the cached entries within memory location 218 to each of row elements 246 and 248 to determine a match or other correspondence between the cached “ROWNAME” variable and portions of the row elements including the row name sub-elements. Object editor 220 utilizes the comparison to determine whether the row name elements contain a correlation value that resolves the relation dependency.

Based on the comparisons, object editor 220 identifies the “ROW 1” and “ROW 2” element values as correlation values for the “ROWNAME” variable in each of the field name elements copied into memory space 218. Similarly, object editor 220 identifies the “ROW 1” and “ROW 2” element values as correlation values for the “ROWNAME” variable in the PROPERTY3 display property element copied into memory space 218. During continued parsing and in response to each incident of identifying a correlation value, object editor 220 replaces the variables with the identified correlation values within the copy of the XML file 206 that is input to object editor 206. The resultant modified XML file 219 may be transmitted to a second stage stream parser within client node 204 and/or may be stored within a storage repository 222 containing other similarly modified XML files 224.

As shown in FIG. 2C, the replacement by object editor 220 of the variables with the correlation values may be implemented within sub-elements of the structure elements. For example, modified XML file 219 is shown as including the same column elements 242 and 244 and modified row elements 250 and 252. As shown, field name elements were inserted into cell sub-elements of original row elements 246 and 248 to generate modified row elements 250 and 252. For row element 250, a field name element <NAME>COLUMN 1-ROW 1</NAME> is included within a cell that is associated with higher level structure element 242 via the <COLUMNNAME> element property within the cell. The second cell within row element 250 includes the inserted field name element <NAME>COLUMN 2-ROW 1</NAME>.

Client node 204 further includes components for rendering, including displaying, graphic interface objects such as may be described in modified XML files such as XML file 219. A configuration GUI application 225 includes program code for presenting XML template display objects and processing the displayed object based on program code within an XML driver 228 and Java utility 230. Modified XML file 219 is received and stream parsed by a SAX parser 226 which passes the resultant parsed XML data to XML driver 228 and Java utility 230 to be displayed on a display device 232. The resultant displayed graphical interface object 234 includes multiple fields that are each ultimately rendered by the hierarchically layered structure elements such as tables, columns, and rows.

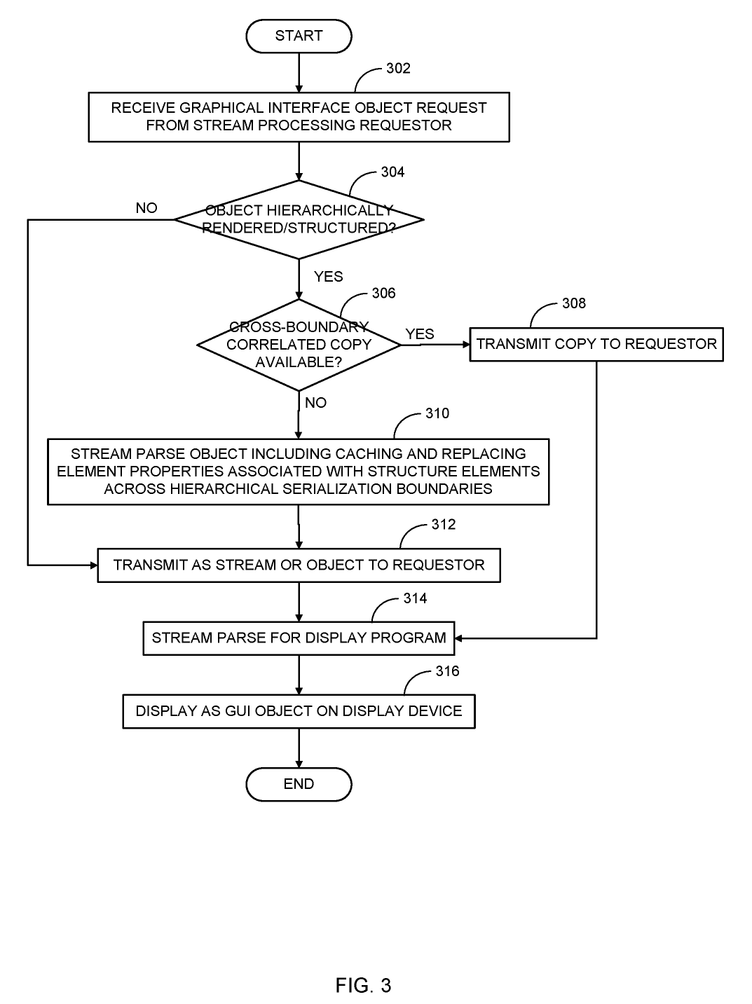

FIG. 3 is a flow diagram depicting operations and functions for rendering a GUI object utilizing dual-stage stream parsing in accordance with some embodiments. The operations and functions depicted and described with reference to FIG. 3 may be performed by the systems, devices, and components depicted in FIGS. 1 and 2A. The process begins as shown at block 302 with a template server node receiving a request for a graphical interface object from a client node. The request may specify an object ID such as an application layer object ID that the template server associates with an XML object ID such as an XML file name. The requesting client node may be a GUI rendering application that utilizes a stream parser, such as a SAX parser to parse XML descriptions of graphic interface objects.

Having identified the particular requested XML object within a storage system or otherwise, the server node determines whether the requested object comprises object elements that are hierarchically rendered for ultimate display (block 304). For instance, the requested XML object identifier may be classified by ID or otherwise as being hierarchically structured in this manner. In response to determining that the requested object is not hierarchically structured, control passes to block 312 at which the server node transmits the requested object as a stream or as a complete file. In response to the server node determining such as via file classification at block 304 that the requested object is hierarchically structured, control passes to block 306 with the server node determining whether a modified copy of the requested object, such as XML file 219, is available. If a modified copy is available, the server node transmits the modified copy to the requesting client (block 308).

In response to determining that a modified copy is not available, control passes to block 310 with the server node utilizing a stream parsing technique to modify the requested file. In some embodiments, the parsing includes including caching portions of structure elements having dependent relations with other elements in a manner such that event-based stream parsing would otherwise result in hierarchical serialized boundaries. For example, the server node may include a content handler that performs the functions described with reference to FIGS. 2A and 2B to cache the selected portions of the graphical interface object. The cached portions are utilized by the server node to modify the requested object by replacing the cached portions with identified correlation values as described with reference to FIGS. 2A and 2C. At block 312, the server node transmits the modified object to the requesting node. Having received the modified object, the client node stream parses as part of a software application that renders a graphical interface on a display device (blocks 314 and 316).

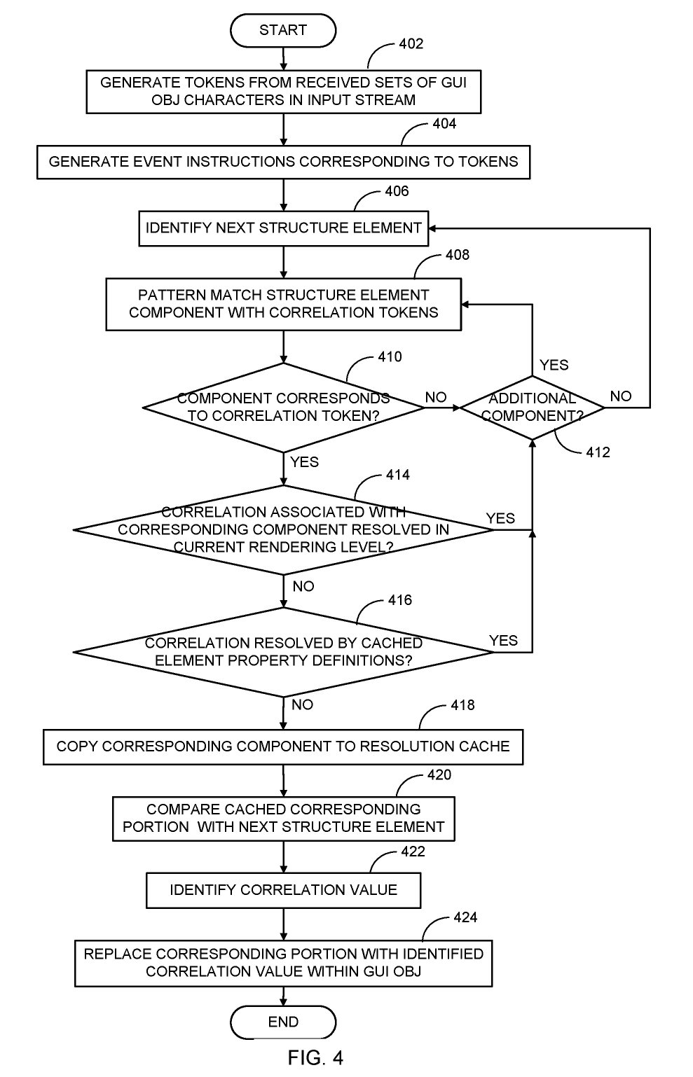

FIG. 4 is a flow diagram illustrating operations and functions for modifying a GUI object in accordance with some embodiments. The operations and functions depicted and described with reference to FIG. 4 may be performed by the systems, devices, and components depicted in FIGS. 1 and 2A. The process begins as shown at block 402 with a stream parser tokenizing an input character stream of the content of a GUI object, such as an XML file. The stream parser reads sets of one or more of the characters and generates corresponding tokens that can be read and otherwise processed by other components of the stream parser such as a content handler. At block 404, the content handler generates event instructions corresponding to each of the sequence of tokens.

In addition to and during the course of generating the event instructions, the content handler sequentially identifies a next structure element specified by the token sequence (block 406). For example, the event handler may be configured to recognize types of elements such as tables, columns, rows, and cells as structure-type elements. Having identified the next element as a structure element, the content handler performs an iterative pattern match comparison of one or more correlation tokens with components (e.g., sub-elements) of the structure element to determine whether the respect components are associated with a dependency relation (block 408). For the first component, the content handler determines whether the component corresponds to a correlation token (block 410). If not, control passes to block 412 for a determination of whether additional components remain to be processed in the structure element. When all components have been processed, control passes back to block 406 with identification of a subsequent structure element in the stream. Otherwise control passes back to block 408.

Returning to block 410, in response to determining that the component corresponds to a correlation token thereby indicating association with a dependency relation (i.e., a “correlation”), control passes to block 414 with the content handler determining whether the correlation that is associated with the component is resolved within the structure element. In some embodiments, the content handler determines that the correlation associated with the corresponding portion of the first structure element is not resolved within the first structure element including determining whether the correlation is further associated with another structure element within a second field rendering level. In other embodiments, the content handler may determine whether the correlation is resolved within the hierarchical rendering level of the structure element. If so, control passes to block 412 to commence processing of the next component within the structure element. Otherwise, in response to determining that the correlation is resolved within the structure element or at least within the same rendering level, control passes to block 416 with the content handler determining whether the correlation is resolved by data artifacts such as display property values that have been cached within the execution memory space utilized by the content handler.

If so, control passes to block 412 to commence processing of the next component within the structure element. Otherwise, control passes to block 418 at which the content handler copies the component to a resolution cache within the execution memory space of the content handler. During parsing of subsequent structure elements, the content handler compares the copied components within the resolution cache to portions (e.g., elements, tags, values) of structure elements to identify correlation values (blocks 420 and 422). The content handler may remove the corresponding component from the resolution cache in response to identifying the correlation value. In further response to identifying the correlation value based at least in part on comparing the copied corresponding portion to the structure element, the content handler may remove the corresponding portion from the resolution cache. The process ends at block 424 with the content handler replacing portions of the GUI object with the identified correlation values.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

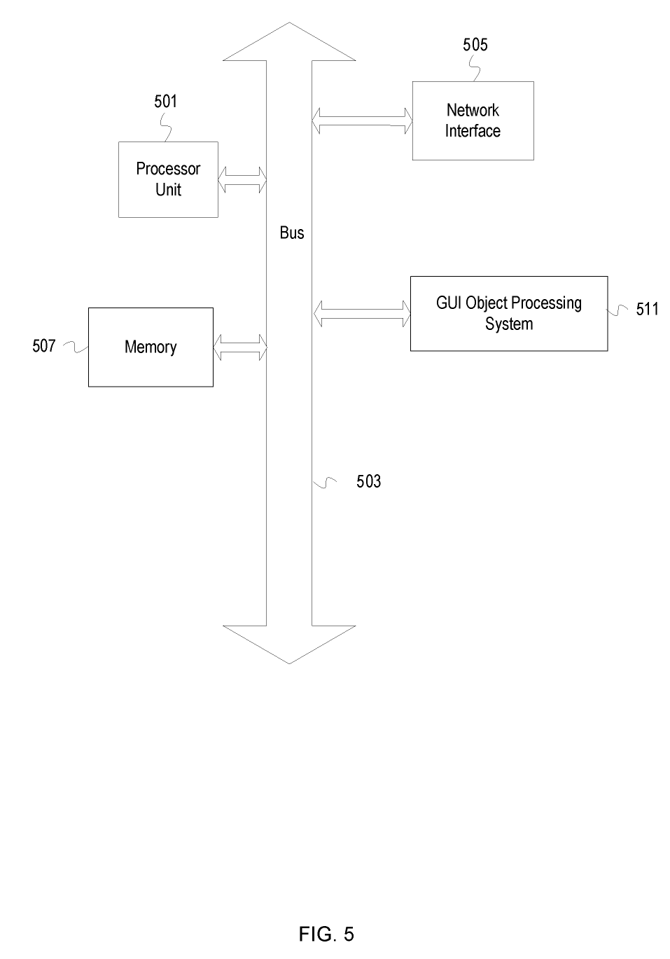

FIG. 5 depicts an example computer system that implements GUI object modification and rendering in accordance with some embodiments. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a GUI object processor 511 such as may incorporate the systems, devices, and components depicted in FIGS. 1 and 2. The GUI object processor 511 provides program structures for modifying and rendering GUI objects as described with reference to FIGS. 1-4. To this end, the GUI object processor 511 may incorporate and/or utilize some or all of the system, devices, components, and data structures described in FIGS. 1-3.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for an object storage backed file system that efficiently manipulates namespace as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
stream parsing structure elements within a graphical interface object, wherein said stream parsing includes,
for a first structure element within a first field rendering level, comparing one or more correlation tokens to the first structure element;
determining, based on said comparing, that a portion of the first structure element corresponds to at least one of the correlation tokens; and
in response, at least in part, to determining that a correlation associated with the corresponding portion of the first structure element is not resolved within the first structure element, copying the corresponding portion to a resolution cache; and
during subsequent stream parsing of each of one or more of the structure elements, comparing the copied corresponding portion to the structure element; and
in response to identifying a correlation value based, at least in part, on said comparing, replacing within the graphical interface object the corresponding portion with the correlation value.

2. The method of claim 1, wherein the corresponding portion comprises an element property variable, wherein said comparing the copied corresponding portion to the structure element comprises:
determining a match between the element property variable and an element property within the structure element, wherein the element property includes a property value and a property identifier; and
determining that a sub-element within the structure element incorporates the element property variable.

3. The method of claim 1, further comprising copying the corresponding portion to the resolution cache in response, at least in part, to determining that the correlation associated with the corresponding portion is not resolved by element property definitions within the resolution cache.

4. The method of claim 1, further comprising identifying the correlation value based, at least in part, on said comparing, wherein the comparing includes comparing an element identifier (ID) of the corresponding portion with an element ID of subsequently parsed structure elements.

5. The method of claim 1, further comprising determining that the correlation associated with the corresponding portion of the first structure element is not resolved within the first structure element including determining whether the correlation is further associated with another structure element within a second field rendering level.

6. The method of claim 1, wherein the correlation associated with the corresponding portion comprises an element property value assignment from a second structure element in a second field rendering level to the corresponding portion within the first structure element.

7. The method of claim 1, further comprising removing the corresponding portion from the resolution cache in response to identifying the correlation value based at least in part on said comparing the copied corresponding portion to the structure element.

8. One or more non-transitory machine-readable media comprising program code for stream parsing a graphical interface object, the program code to:
stream parse structure elements within the graphical interface object, wherein said stream parsing includes,
for a first structure element within a first field rendering level, comparing one or more correlation tokens to the first structure element;
determining, based on said comparing, that a portion of the first structure element corresponds to at least one of the correlation tokens; and
in response, at least in part, to determining that a correlation associated with the corresponding portion of the first structure element is not resolved within the first structure element, copying the corresponding portion to a resolution cache; and
during subsequent stream parsing of each of one or more of the structure elements, comparing the copied corresponding portion to the structure element; and
in response to identifying a correlation value based, at least in part, on said comparing, replacing within the graphical interface object the corresponding portion with the correlation value.

9. The machine-readable media of claim 8, wherein the corresponding portion comprises an element property variable, wherein said comparing the copied corresponding portion to the structure element comprises:
determining a match between the element property variable and an element property within the structure element, wherein the element property includes a property value and a property identifier; and
determining that a sub-element within the structure element incorporates the element property variable.

10. The machine-readable media of claim 8, wherein the program code further comprises program code to copy the corresponding portion to the resolution cache in response, at least in part, to determining that the correlation associated with the corresponding portion is not resolved by element property definitions within the resolution cache.

11. The machine-readable media of claim 8, wherein the program code further comprises program code to identify the correlation value based, at least in part, on said comparing, wherein the comparing includes comparing an element identifier (ID) of the corresponding portion with an element ID of subsequently parsed structure elements.

12. The machine-readable media of claim 8, wherein the program code further comprises program code to determine that the correlation associated with the corresponding portion of the first structure element is not resolved within the first structure element including determining whether the correlation is further associated with another structure element within a second field rendering level.

13. The machine-readable media of claim 8, wherein the correlation associated with the corresponding portion comprises an element property value assignment from a second structure element in a second field rendering level to the corresponding portion within the first structure element.

14. The machine-readable media of claim 8, wherein the program code further comprises program code to remove the corresponding portion from the resolution cache in response to identifying the correlation value based at least in part on said comparing the copied corresponding portion to the structure element.

15. An apparatus comprising:
a processor; and
a machine-readable medium having program code executable by the processor to cause the apparatus to,
stream parse structure elements within the graphical interface object, wherein said stream parsing includes,
for a first structure element within a first field rendering level, comparing one or more correlation tokens to the first structure element;
determining, based on said comparing, that a portion of the first structure element corresponds to at least one of the correlation tokens; and
in response, at least in part, to determining that a correlation associated with the corresponding portion of the first structure element is not resolved within the first structure element, copying the corresponding portion to a resolution cache; and
during subsequent stream parsing of each of one or more of the structure elements, comparing the copied corresponding portion to the structure element; and
in response to identifying a correlation value based, at least in part, on said comparing, replacing within the graphical interface object the corresponding portion with the correlation value.

16. The apparatus of claim 15, wherein the corresponding portion comprises an element property variable, wherein said comparing the copied corresponding portion to the structure element comprises:
determining a match between the element property variable and an element property within the structure element, wherein the element property includes a property value and a property identifier; and
determining that a sub-element within the structure element incorporates the element property variable.

17. The apparatus of claim 15, wherein the program code further comprises program code executable by the processor to cause the apparatus to copy the corresponding portion to the resolution cache in response, at least in part, to determining that the correlation associated with the corresponding portion is not resolved by element property definitions within the resolution cache.

18. The apparatus of claim 15, wherein the program code further comprises program code executable by the processor to cause the apparatus to identify the correlation value based, at least in part, on said comparing, wherein the comparing includes comparing an element identifier (ID) of the corresponding portion with an element ID of subsequently parsed structure elements.

19. The apparatus of claim 15, wherein the program code further comprises program code executable by the processor to cause the apparatus to determine that the correlation associated with the corresponding portion of the first structure element is not resolved within the first structure element including determining whether the correlation is further associated with another structure element within a second field rendering level.

20. The apparatus of claim 15, wherein the correlation associated with the corresponding portion comprises an element property value assignment from a second structure element in a second field rendering level to the corresponding portion within the first structure element.
